(19) United States
(12) Patent Application Publication
(10) Pub. No.: US 2021/0356845 A1
(43) Pub. Date: Nov. 18, 2021

(54) Optical Imaging Lens

(71) Applicant: ZHEJIANG SUNNY OPTICS CO.,LTD., Ningbo (CN)

(72) Inventors: Libang CHENG, Ningbo (CN); Kaikai ZHANG, Ningbo (CN); Zeguang WANG, Ningbo (CN); Fujian DAI, Ningbo (CN); Liefeng ZHAO, Ningbo (CN)

(21) Appl. No.: 17/170,902

(22) Filed: Feb. 9, 2021

(30) Foreign Application Priority Data
May 12, 2020 (CN) 202020780286.0

(51) Int. Cl. G03B 17/12; G02B 7/02; G02B 7/38

(52) U.S. Cl. CPC G03B 17/12; G02B 7/38; G02B 7/022

(57) ABSTRACT

The disclosure provides an optical imaging lens. The optical imaging lens includes a lens barrel and a plurality of lenses. The lens barrel is provided with an object-side end face and an image-side end face; the object-side end face has a tooth and groove structure that is arranged around a circumference of the lens barrel and extends in a direction away from a center axis of the lens barrel. The plurality of lenses are arranged at intervals along the center axis. The disclosure solves the problem that optical imaging lenses in the related art fail to achieve both low reflectivity and low cost.

### CROSS-REFERENCE TO RELATED DISCLOSURES

The application claims priority to Chinese Patent Disclosure No. 202020780286.0, filed to the National Intellectual Property Administration, PRC (CNIPA) on May 12, 2020, the disclosure of which is hereby incorporated by reference in its entirety.

### TECHNICAL FIELD

The disclosure relates to the technical field of optical imaging devices, in particular to an optical imaging lens.

### BACKGROUND

With the development of imaging products towards integration, miniaturization, and convenience, it is required to, as much as possible, reduce production cost of imaging camera lenses matched with the imaging products on the premise of ensuring imaging quality. The camera lenses are respectively assembled on overall units, and end faces of the lenses are visible. The end faces of the conventional lenses have high reflectivity, which affects appearances of the overall units and light extinction effects of the camera lenses. At present, there are also processes such as black coating to reduce the reflectivity of the end faces of the camera lenses, but the black coating process is complicated and takes a long time, and the production cost is high, which greatly increases the cost of the camera lenses.

That is to say, the optical imaging lenses in the related art have the problem of failing to achieve both low reflectivity and low cost.

### SUMMARY

Some embodiments of the disclosure is to provide an optical imaging lens, intended to solve the problem that the optical imaging lens in the related art fail to achieve both low reflectivity and low cost.

An embodiment of the disclosure, an optical imaging lens is provided, including a lens barrel and a plurality of lenses. The lens barrel is provided with an object-side end face and an image-side end face; and the object-side end face has a tooth and groove structure that is arranged around a circumference of the lens barrel and extends in a direction away from a center axis of the lens barrel. The plurality of lenses are arranged at intervals along the center axis.

In an embodiment, the object-side end face includes: a end face arranged around a circumference of an inner wall of the lens barrel; and a flared face located on a periphery of the end face, where a major-diameter end of the flared face is close to the image-side end face relative to the end face, and the tooth and groove structure is located on the end face, or the tooth and groove structure is located on the flared face, or the tooth and groove structure is located on the end face and the flared face.

In an embodiment, the tooth and groove structure includes a plurality of tooth structures and a plurality of groove structures. Tooth widths of the plurality of tooth structures are gradually increased in a direction close to the center axis, and each groove structure is formed between every two adjacent tooth structures of the plurality of tooth structures.

In an embodiment, a distance L1 between top surfaces of every two adjacent tooth structures is not less than 0.03 mm and not greater than 0.5 mm.

In an embodiment, a distance L2 between groove bottoms of every two adjacent groove structures is not less than 0.01 mm and not greater than 0.5 mm.

In an embodiment, at a same height, a distance between every two adjacent tooth structures is gradually increased in a direction close to the image-side end face; or at the same height, the distance between every two adjacent tooth structures is the same.

In an embodiment, a tooth height H of each tooth structure of the plurality of tooth structures is not less than 0.01 mm.

In an embodiment, a section, in a direction perpendicular to the center axis, of each tooth structure of the plurality of tooth structures is shaped as a sharp corner, and an angle of the sharp corner is greater than or equal to 0 degree.

In an embodiment, area of sections, in a direction parallel to the groove bottoms, of the groove structures is gradually increased in a direction away from the groove bottoms; or area of sections, in a direction parallel to the center axis, of the tooth structures is gradually decreased in a direction away from the center axis; or area of sections, in a direction parallel to the groove bottoms, of the groove structures is gradually increased in a direction away from the groove bottoms, area of sections, in a direction parallel to the center axis, of the tooth structures is gradually decreased in a direction away from the center axis.

In an embodiment, a top surface of each tooth structure of the plurality of tooth structures is a plane; or the top surface of each tooth structure of the plurality of tooth structures is serrated; or the top surface of each tooth structure of the plurality of tooth structures has recesses.

By applying the technical solution of the disclosure, the optical imaging lens includes a lens barrel and a plurality of lenses. The lens barrel is provided with an object-side end face and an image-side end face; and the object-side end face has a tooth and groove structure that is arranged around the circumference of the lens barrel and extends in a direction away from a center axis of the lens barrel. The plurality of lenses are arranged at intervals along the center axis.

With the tooth and groove structure arranged on the object-side end face, the object-side end face is darker, and accordingly can well absorb light that is incident on the object-side end face, and reduce stray light entering the lenses, to ensure imaging quality of the optical imaging lens. Since the object-side end face is provided with the tooth and groove structure, the black coating process performed on the object-side end face is omitted, processing steps are greatly simplified, and production cost is saved. The reflectivity of the optical imaging lens in the present application can be reduced without increasing manufacturing cost, so that the problem of failing to achieve both low reflectivity and low cost is solved.

### BRIEF DESCRIPTION OF THE DRAWINGS

Drawings of the description for constituting a part of the present application are used to provide further understanding of the disclosure, and exemplary embodiments of the disclosure and descriptions thereof are used to explain the disclosure, and do not constitute improper limitation to the disclosure. In the drawings:

FIG. 1 shows a schematic structural diagram of an object-side end face of a lens barrel according to an optional embodiment of the disclosure; and

FIG. 2 shows a schematic structural diagram of a tooth and groove structure in FIG. 1.

Herein, the above drawings include the following reference signs:

10, object-side end face; 11, end face; 12, flared face; 20, tooth and groove structure; 21, tooth structure; and 22. groove structure.

### DETAILED DESCRIPTION OF THE EMBODIMENTS

It is to be noted that embodiments in the present application and characteristics in the embodiments may be combined under the condition of no conflicts. The disclosure is described below with reference to the drawings and in conjunction with the embodiments in detail.

It is to be noted that all technical and scientific terms used herein have the same meaning as commonly understood by those of ordinary skill in the art to which the present application belongs, unless otherwise indicated.

In the disclosure, if there is no explanation to the contrary, the orientation words used such as “up, down, top, and bottom” are usually for the direction shown in the drawings, or for the vertical, perpendicular or gravitational direction of each component itself. Similarly, for ease of understanding and description, “inner and outer” refers to the inner and outer parts relative to the contour of each component itself, but the above-mentioned orientation words are not used to limit the disclosure.

In order to solve the problem that the optimal imaging camera lenses in the related art fail to achieve both low reflectivity and low cost, the disclosure provides an optimal imaging camera lens.

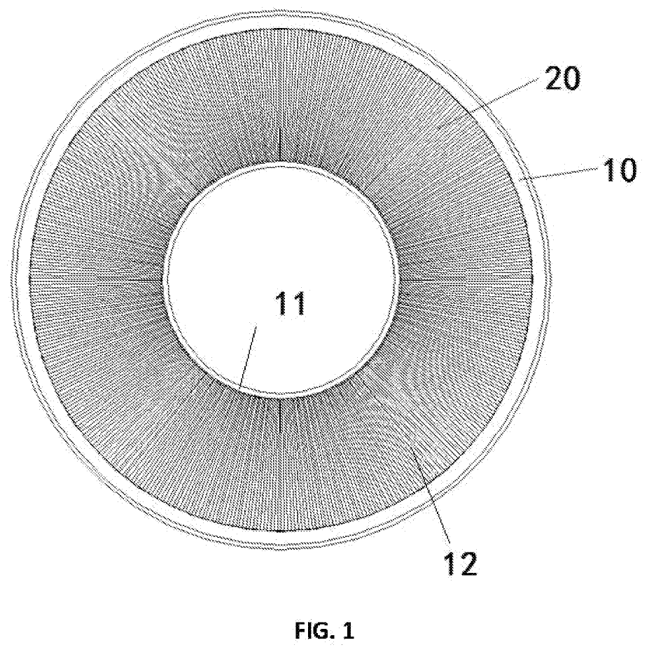

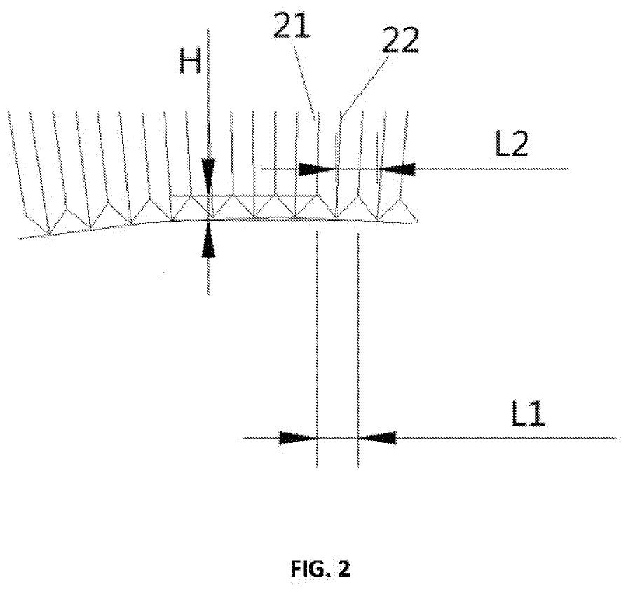

As shown in FIG. 1 to FIG. 2, the optical imaging lens includes a lens barrel and a plurality of lenses. The lens barrel is provided with an object-side end face 10 and an image-side end face; and the object-side end face 10 has a tooth and groove structure 20 that is arranged around a circumference of the lens barrel and extends in a direction away from the center axis of the lens barrel. The plurality of lenses are arranged at intervals along the center axis.

With the tooth and groove structure 20 arranged on the object-side end face 10, the object-side end face 10 is darker, and accordingly can well absorb light that is incident thereon and reduce stray light entering the lenses, to ensure imaging quality of the optical imaging lens. Since the object-side end face 10 is provided with the tooth and groove structure 20, a black coating process performed on the object-side end face 10 is omitted, processing steps are greatly simplified, and production cost is saved. The reflectivity of the optical imaging lens in the present application can be reduced without increasing manufacturing cost, so that the problem of failing to achieve both low reflectivity and low cost is solved.

The object-side end face 10 includes a end face 11 and a flared face 12. The end face 11 is arranged on a circumference of an inner wall of the lens barrel; and the flared face 12 is located on a periphery of the end face 11, a major-diameter end of the flared face 12 is close to the image-side end face relative to the end face 11, and the tooth and groove structure 20 is located on the flared face 12. In FIG. 2, the tooth and groove structure 20 is only located on the flared face 12. In an not shown embodiment, the tooth and groove structure 20 is located on the end face 11 and the flared face 12. After the optical imaging lens is mounted on an image device, the end face 11 is exposed to the outside, which facilitates incidence of light into the lens. The tooth and groove structure 20 arranged on the end face 11 may prevent light reflecting on the end face 11 during imaging, so as to reduce the stray light entering the lenses. The flared face 12 is arranged on the outer side of the end′face 11, and light that is incident on the flared face 12 is easy to be reflected. The tooth and groove structure 20 arranged on the flared face 12 may also reduce the stray light entering the lenses to improve imaging quality of the optical imaging lens.

As shown in FIG. 2, the tooth and groove structure 20 includes a plurality of tooth structures 21 and a plurality of groove structures 22. Tooth widths of the plurality of tooth structures 21 are gradually increased in a direction close to the center axis, and each groove structure 22 is formed between every two adjacent tooth structures 21 corresponding thereto. The tooth and groove structure includes a plurality of tooth structures 21 and a plurality of groove structures 22, the light entering the tooth and groove structure 20 may be only reflected therein rather than be reflected into the lenses, so that the imaging quality of the optical imaging lens may be guaranteed.

Particularly, a distance L1 between top surfaces of every two adjacent tooth structures 21 is not less than 0.03 mm and not greater than 0.5 mm. If the distance between top surfaces of every two tooth structures 21 is less than 0.03 mm, the distance between the two adjacent tooth structures 21 is too small, which is unfavourable for incidence of light into the groove structure 22 corresponding thereto and makes the reflectivity of the groove structure 22 excessive. If the distance between top surfaces of every two adjacent tooth structures 21 is greater than 0.5 mm, the distance between the two adjacent tooth structures 21 is excessive, the light that is incident on the tooth structures 21 is easy to be reflected into the lenses, so that the imaging quality of the optical imaging lens is reduced. If the distance between the top surfaces of every two adjacent tooth structures 21 is limited within a range of 0.03 mm to 0.5 mm, a low reflectivity of the tooth and groove structure 20 may be guaranteed, while the optical imaging lens has high imaging quality.

Particularly, a distance L2 between groove bottoms of every two adjacent groove structures 22 is not less than 0.01 mm and not greater than 0.5 mm. If the distance between the groove bottoms of every two adjacent groove structure 22 is less than 0.01 mm, the tooth and groove structure 20 is poor in strength, and the tooth and groove structure 20 is easy to be broken, which is unfavourable for working stability of the tooth and groove structure 20. When the distance between the groove bottoms of every two adjacent groove structures 22 is greater than 0.5 mm, the tooth structures 21 corresponding thereto occupy large space, which is unfavourable for thinning of the tooth and groove structure 20. The distance of the groove bottoms of every two adjacent groove structures 22 is limited within a range of 0.01 mm to 0.5 m, which is beneficial to thinning of the tooth and groove structure 20 on the premise of guaranteeing the structural strength of the tooth and groove structure 20.

In an embodiment, at the same height, the distance between every two adjacent tooth structures 21 is gradually increased in a direction close to the image-side end face. Since the object-side end face 10 is shaped as a circular truncated cone surface, manufacturing of the tooth structures 21 is facilitated, tooth widths of the tooth structures 21 at the same height are constant.

In another embodiment, the distance between every two adjacent tooth structures 21 at the same height can also be the same. This arrangement makes the tooth widths of the tooth structures 21 at the same height changing, which is unfavourable for manufacturing of the tooth structures 21. However, such tooth structures 21 have better light absorption effects.

In the disclosure, a tooth spacing between every two adjacent tooth structures 21 is not less than 0.01 mm and not greater than 0.5 mm. Since the tooth spacing between every two adjacent tooth structures 21 is limited within a range of 0.01 mm to 0.5 mm, light that is incident on the tooth structures 21 cannot be reflected to the lenses, and the stray light at the lenses is reduced.

Particularly, a tooth height H of each tooth structure 21 is not less than 0.01 mm. This arrangement facilitates light absorption of the tooth and groove structure 20, thereby greatly reducing light reflected to the lenses by the tooth and groove structure 20, and improving the imaging quality of the optical imaging lens.

As shown in FIG. 2, a section, in a direction perpendicular to the center axis, of each tooth structure 21 is shaped as a sharp corner, and an angle of the sharp corner is greater than or equal to 0 degree. Since the section, in a direction perpendicular to the center axis, of each tooth structure 21 is arranged as, a sharp corner, space occupation of the top surface of the tooth structure 21 may be reduced, which facilitates incidence of light into the groove structure 22 corresponding thereto, to increase light absorption of the tooth and groove structure 20, reduce the stray light entering the lenses, so as to improve the imaging quality of the optical imaging lens.

As shown in FIG. 2, area of sections, in a direction parallel to the groove bottoms, of the groove structures 22 is gradually increased in a direction away from the bottoms; and area of sections, in a direction parallel to the center axis, of the tooth structures 21 is gradually decreased in a direction away from the center axis. According to this arrangement, the groove structures 22 are flared to the openings from the bottoms, which facilitates incidence of light into the groove structures 22 and reduction of the reflectivity of the tooth and groove structure 20, thereby reducing the stray light entering the lenses, and improving the imaging quality of the optical imaging lens.

In a not shown embodiment, a top surface of each tooth structure 21 is a plane. The top surface of each tooth structure 21 is configured as a plane, which facilitates manufacturing of the tooth structure 21, but has a high reflectivity.

The top surface of each tooth structure 21 may also be of a microstructure, for example, the top surface of the tooth structure 21 is serrated; or the top surface of the tooth structure 21 has recesses. Although it is not easy to manufacture the structure, the structure has good light absorption effect and low reflectivity, which is conducive to formation of clear images by the optical imaging lens.

It is apparent that the above-described embodiments are only part of the embodiments of the disclosure, not all of the embodiments. On the basis of the embodiments of the disclosure, all other embodiments obtained on the premise of no creative work of those of ordinary skill in the art should fall within the scope of protection of the disclosure.

It is to be noted that the terms used here are only used for describing the specific implementation modes, and are not intended to limit the exemplary implementation modes according to the present application. As used herein, unless clearly specified otherwise in the context, the singular form is also intended to include the plural form. In addition, it should also be understood that when the terms “comprising” and/or “including” are used in the description, it is indicated that there are features, steps, operations, devices, components and/or combinations thereof.

It is to be noted that the terms “first”, “second”, and the like in the specification and claims of the present application and in the above drawings are used to distinguish similar objects and are not necessarily used to describe a specific sequence or order. It will be appreciated that the data used in this way may be interchanged where appropriate, so that the implementation manners of the present application described herein may be implemented in an order other than those illustrated or described herein.

The foregoing descriptions are merely preferred embodiments of the disclosure and are not intended to limit the disclosure. For those skilled in the art, the disclosure may have various changes and modifications. Any modifications, equivalent replacements and improvements made within the spirit and principle of the disclosure shall fall within the protection scope of the disclosure.

What is claimed is:

1. An optical imaging lens, comprising:
a lens barrel, wherein the lens barrel is provided with an object-side end face and an image-side end face, and the object-side end face has a tooth and groove structure that is arranged around a circumference of the lens barrel and extends in a direction away from a center axis of the lens barrel; and
a plurality of tenses, the plurality of lenses are arranged at intervals along the center axis.

2. The optical imaging lens as claimed in claim 1, wherein the object-side end face comprises:
a end face arranged around a circumference of an inner wall of the lens barrel; and
a flared face located on a periphery of the end face, wherein a major-diameter end of the flared face is close to the image-side end face relative to the end face, and the tooth and groove structure is located on the end face or the flared face, or the tooth and groove structure is located on the end face and the flared face.

3. The optical imaging lens as claimed in claim 1, wherein the tooth and groove structure comprises a plurality of tooth structures and a plurality of groove structures, tooth widths of the plurality of tooth structures are gradually increased in a direction close to the center axis, and each groove structure is formed between every two adjacent tooth structures of the plurality of tooth structures.

4. The optical imaging lens as claimed in claim 3, wherein a distance L1 between top surfaces of every two adjacent tooth structures is not less than 0.03 mm and not greater than 0.5 mm.

5. The optical imaging lens as claimed in claim 3, wherein a distance L2 between groove bottoms of every two adjacent groove structures is not less than 0:01 mm and not greater than 0.5 mm.

6. The optical imaging lens as claimed in claim 3, wherein
at a same height, a distance between every two adjacent tooth structures is gradually increased in a direction close to the image-side end face; or
at the same height, the distance between every two adjacent tooth structures is the same.

7. The optical imaging lens as claimed in claim 3, wherein a tooth height H of each tooth structure of the plurality of tooth structures is not less than 0.01 mm.

8. The optical imaging lens as claimed in claim 3, wherein a section, in a direction perpendicular to the center axis, of each tooth structure of the plurality of tooth structures is shaped as a sharp corner, and an angle of the sharp corner is greater than or equal to 0 degree.

9. The optical imaging lens as claimed in claim 3, wherein
area of sections, in a direction parallel to groove bottoms, of the groove structures is gradually increased in a direction away from the groove bottoms; or
area of sections, in a direction parallel to the center axis, of the tooth structures is gradually decreased in a direction away from the center axis; or
area of sections, in a direction parallel to groove bottoms, of the groove structures is gradually increased in a direction away from the groove bottoms, area of sections, in a direction parallel to the center axis, of the tooth structures is gradually decreased in a direction away from the center axis.

10. The optical imaging lens as claimed in claim 3, wherein
a top surface of each tooth structure of the plurality of tooth structures is a plane; or
the top surface of each tooth structure of the plurality of tooth structures is serrated; or
the top surface of each tooth structure of the plurality of tooth structures has recesses.

11. The optical imaging lens as claimed in claim 4, wherein
a top surface of each tooth structure of the plurality of tooth structures is a plane; or
the top surface of each tooth structure of the plurality of tooth structures is serrated; or
the top surface of each tooth structure of the plurality of tooth structures has recesses.

12. The optical imaging lens as claimed in claim 5, wherein
a top surface of each tooth structure of the plurality of tooth structures is a plane; or
the top surface of each tooth structure of the plurality of tooth structures is serrated; or
the top surface of each tooth structure of the plurality of tooth structures has recesses.

13. The optical imaging lens as claimed in claim 6, wherein
a top surface of each tooth structure of the plurality of tooth structures is a plane; or
the top surface of each tooth structure of the plurality of tooth structures is serrated; or
the top surface of each tooth structure of the plurality of tooth structures has recesses.

14. The optical imaging lens as claimed in claim 7, wherein
a top surface of each tooth structure of the plurality of tooth structures is a plane; or
the top surface of each tooth structure of the plurality of tooth structures is serrated; or
the top surface of each tooth structure of the plurality of tooth structures, has recesses.

15. The optical imaging lens as claimed in claim 8, wherein
a top surface of each tooth structure of the plurality of tooth structures is a plane; or
the top surface of each tooth structure of the plurality of tooth structures is serrated; or
the top surface of each tooth structure of the plurality of tooth structures has recesses.

16. The optical imaging lens as claimed in claim 9, wherein
a top surface of each tooth structure of the plurality of tooth structures is a plane; or
the top surface of each tooth structure of the plurality of tooth structures is serrated; or
the top surface of each tooth structure of the plurality of tooth structures has recesses.
